(19) United States
(12) Patent Application Publication
(10) Pub. No.: US 2022/0302516 A1
(43) Pub. Date: Sep. 22, 2022

(54) RECONSTRUCTING METHOD OF BATTERY PACK, MANUFACTURING METHOD OF BATTERY PACK, BATTERY PACK, MANUFACTURING SUPPORT APPARATUS, AND MANUFACTUIRNG SUPPORT METHOD

(71) Applicant: TOYOTA JIDOSHA KABUSHIKI KAISHA, Toyota-shi Aichi-ken (JP)

(72) Inventor: Toshihiko Mitsuhashi, Nagoya-shi Aichi-ken (JP)

(21) Appl. No.: 17/696,216

(22) Filed: Mar. 16, 2022

(30) Foreign Application Priority Data
Mar. 19, 2021 (JP) 2021-045412

(51) Int. Cl. H01M 10/54; H01M 10/04; H01M 10/0525; H01M 10/42

(52) U.S. Cl. CPC H01M 10/54; H01M 10/04; H01M 10/0525; H01M 10/4285; H01M 2220/20

(57) ABSTRACT

A reconstructing method of a battery pack is a reconstructing method of a battery pack including a plurality of laminated cells each having a seal part. The reconstructing method includes an acquisition step of acquiring a prescribed index value indicating a state of the seal part, and an arrangement determination step of determining arrangement of the cell in reconstruction of the battery pack in accordance with the state of the seal part indicated by the acquired prescribed index value

### CROSS-REFERENCE TO RELATED APPLICATION

This application claims priority to Japanese Patent Application No. 2021-045412 filed on Mar. 19, 2021, incorporated herein by reference in its entirety.

### BACKGROUND

### 1. Technical Field

The present disclosure relates to reconstructing methods of a battery pack, manufacturing methods of the battery pack, the battery pack, manufacturing support apparatuses, and manufacturing support methods. The present disclosure particularly relates to a reconstructing method of a laminated battery pack including a plurality of cells each having a seal part, a manufacturing method of the battery pack, the battery pack, a manufacturing support apparatus, and a manufacturing support method.

### 2. Description of Related Art

In the past, there was a method of reusing secondary batteries (see, for example, Japanese Unexamined Patent Application Publication No. 2011-171032). In the method, when a battery pack is reconstructed, battery characteristics of the secondary batteries that constitute the battery pack are acquired, the secondary batteries are classified using an allowable range of variation that varies in accordance with the acquired battery characteristics, and the battery pack is reconstructed for each classified secondary battery.

### SUMMARY

When a battery pack is mounted on a vehicle and used, the temperature of the battery pack varies depending on the regions of the battery pack. The battery characteristics of the secondary batteries (for example, cells) that constitute the battery pack are not the only factor that relates to the life of the batteries.

The present disclosure has been made to cope with the above issues, and an object of the present disclosure is to provide a reconstructing method of a battery pack, a manufacturing method of the battery pack, the battery pack, a manufacturing support apparatus, and a manufacturing support method, capable of extending the life of the battery pack after reconstruction.

The reconstructing method of a battery pack according to the present disclosure is a reconstructing method of a battery pack including a plurality of laminated cells each having a seal part. The reconstructing method includes: an acquisition step of acquiring a prescribed index value indicating a state of the seal part; and an arrangement determination step of determining arrangement of the cells in reconstruction of the battery pack in accordance with the state of the seal part indicated by the acquired prescribed index value.

With such configuration, the arrangement of the cell in reconstruction of the battery pack is determined in accordance with the state of the seal part indicated by the prescribed index value representing the state of the seal part of the cell. When the battery pack is used, influence on the seal parts of the cells are different depending on the arrangement of the cells. The life of the cells varies depending on the state of the seal parts of the cells. Therefore, it is possible to reconstruct the cells into a battery pack so as to extend the life of the cells. As a result, it is possible to provide the reconstructing method of a battery pack capable of extending the life of the battery pack after reconstruction.

In the acquisition step, the prescribed index value may be acquired by measuring the prescribed index value of the seal part of the cell that is disassembled from the collected battery pack, and the reconstructing method may further include a step of determining not to use the cell for reconstruction of the battery pack when the acquired prescribed index value of the cell does not satisfy a specified value. With such configuration, when the seal part of a certain cell has a prescribed index value that does not satisfy the prescribed value, using the cell, which affects the life of a reconstructed battery pack, for reconstruction of the battery pack can be avoided. As a result, it is possible to extend the life of the battery pack after reconstruction.

In the arrangement determination step, as the state of the seal part indicated by the acquired prescribed index value is better, the cell of the prescribed index value may be determined to be arranged at a region where temperature becomes higher when the battery pack is used. The region where the temperature rises when the battery pack is used has a large influence on the seal part. With such configuration, the cell having the seal part in a good state can be arranged at the region where the seal part is largely influenced. As a result, it is possible to extend the life of the battery pack after reconstruction.

In the arrangement determination step, when the prescribed index value is equal to or more than a prescribed value representing a good state of the seal part, the cell of the prescribed index value may be determined to be arranged at the region where temperature becomes equal to or more than a prescribed temperature when the battery pack is used, whereas when the prescribed index value is less than the prescribed value, the cell of the prescribed index value may be determined to be arranged at the region where temperature does not become equal to or more than the prescribed temperature when the battery pack is used. With such configuration, it is possible to arrange the cell having the seal part in a good state at the region where the seal part receives a relatively large influence, and to arrange the cell having the seal part in a poor state at the region where the seal part receives a relatively small influence. As a result, it is possible to extend the life of the battery pack after reconstruction.

According to another aspect of the present disclosure, the manufacturing method of a battery pack is a manufacturing method of a battery pack including a plurality of laminated cells each having a seal part. The manufacturing method includes: a step of acquiring a prescribed index value indicating a state of the seal part of the cell that is disassembled from the collected battery pack; a step of determining a region where the cell is arranged in reconstruction of the battery pack in accordance with the state of the seal part indicated by the acquired prescribed index value; and a step of reconstructing the battery pack by arranging the cell at the determined region.

With such configuration, it is possible to provide the manufacturing method of a battery pack capable of extending the life of the battery pack after reconstruction.

According to still another aspect of the present disclosure, a battery pack is manufactured by the manufacturing method. With such configuration, it is possible to provide a battery pack capable of extending the life of the battery pack after reconstruction.

According to yet another aspect of the present disclosure, the manufacturing support apparatus for a battery pack is a manufacturing support apparatus for a battery pack including a plurality of laminated cells each having a seal part. The manufacturing support apparatus includes: an arithmetic processing unit; and a storage unit. The arithmetic processing unit is configured to store an acquired prescribed index value indicating a state of the seal part in the storage unit, and determine arrangement of the cell in reconstruction of the battery pack in accordance with the state of the seal part indicated by the prescribed index value stored in the storage unit.

With such configuration, it is possible to provide the manufacturing support apparatus of a battery pack capable of extending the life of the battery pack after reconstruction.

According to yet another aspect of the present disclosure, the manufacturing support method for a battery pack is a manufacturing support method for a battery pack including a plurality of laminated cells each having a seal part. The manufacturing support method is executed by a manufacturing support apparatus including an arithmetic processing unit and a storage unit. The manufacturing support method includes: a step of the arithmetic processing unit storing an acquired prescribed index value indicating a state of the seal part in the storage unit; and a step of the arithmetic processing unit determining arrangement of the cell in reconstruction of the battery pack in accordance with the state of the seal part indicated by the prescribed index value stored in the storage unit.

With such configuration, it is possible to provide the manufacturing support method for a battery pack capable of extending the life of the battery pack after reconstruction.

The present disclosure can provide a reconstructing method of a battery pack, a manufacturing method of a battery pack, a battery pack, a manufacturing support apparatus, and a manufacturing support method, capable of extending the life of the battery pack after reconstruction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an aspect of distribution of battery packs from collection to manufacturing and selling;

FIG. 2 is a flowchart showing a processing flow in a battery distribution model;

FIG. 3 shows a configuration example of a battery management system that is applied to the battery distribution model in an embodiment;

FIG. 4 shows outlined configuration of a vehicle, a management server, and a terminal of a manufacturer in the embodiment;

FIG. 5 is an explanatory view of an example of temperature distribution in a battery pack mounted on a vehicle in a first embodiment;

FIG. 6 is a flowchart showing a flow of battery manufacturing support processing in the first embodiment;

FIG. 7A is a plan view of the cell for describing inspection of a seal width of a cell in the embodiment;

FIG. 7B is a partial sectional view of the cell for describing inspection of a seal width of a cell in the embodiment;

FIG. 8A is another plan view of the cell for describing inspection of the seal width of the cell in the embodiment;

FIG. 8B is another partial sectional view of the cell for describing inspection of a seal width of a cell in the embodiment;

FIG. 9 is an explanatory view of an example of temperature distribution in a battery pack mounted on a vehicle in a second embodiment; and

FIG. 10 is a flowchart showing a flow of battery manufacturing support processing in the second embodiment.

### DETAILED DESCRIPTION OF EMBODIMENTS

Hereinafter, embodiments of the present disclosure will be described with reference to the drawings. In the description below, identical component parts are denoted by identical signs. This also applies to the name and function of the identical component parts. Therefore, the detailed description of the identical component parts is not repeatedly provided.

In the present disclosure, a battery pack includes a plurality of stacks (also referred to as modules or blocks). The stacks may be connected in series or in parallel. Each of the stacks includes a plurality of cells connected in series or in parallel.

Typically, the “reuse” of battery packs is broadly divided into reuse, rebuild and recycling. In the case of reuse, a collected battery packs is subjected to necessary shipment inspection and then shipped as it is as a reuse product. In the case of rebuild, the collected battery pack is disassembled into stacks or cells, for example. Then, out of the disassembled stacks or cells, reusable stack or cells are combined to manufacture a new battery pack (reconstruction). The newly manufactured battery pack is subjected to necessary shipment inspection and then shipped as a rebuilt product. In contrast, in the case of recycling (resource recycling), recyclable materials are extracted from each cell. Accordingly, the collected battery pack is not used as another battery pack.

### First Embodiment

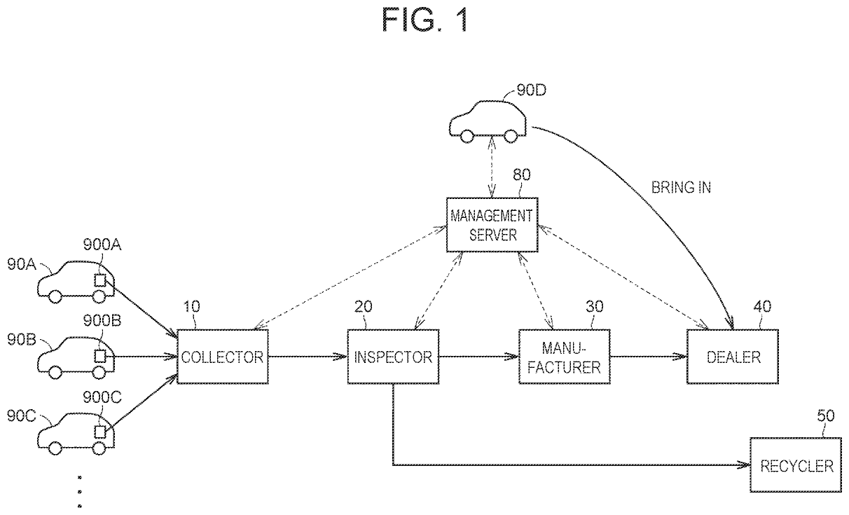

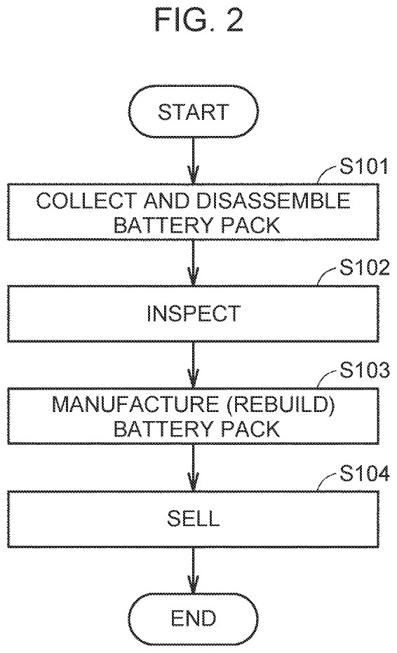

FIG. 1 shows an aspect of distribution of battery packs from collection to manufacturing and selling. Hereinafter, the aspect of distribution shown in FIG. 1 is referred to as “battery distribution model”. FIG. 2 is a flowchart showing a processing flow in the battery distribution model.

With reference to FIGS. 1 and 2, in the battery distribution model, battery packs 900A to 900C are collected from a plurality of vehicles 90A to 90D. In the present embodiment, used cells are extracted from the collected battery packs 900A to 900C, and reusable cells are reused to manufacture (reconstruct) and sell a battery pack 900. The battery pack 900 is replaced with another battery pack 900 mounted on a vehicle 90 of a certain user.

A collector 10 collects used battery packs 900A to 900C from the vehicles 90A to 90C. The vehicles 90A to 90C are mounted with the battery packs 900A to 900C, respectively. In FIG. 1, only three vehicles are shown due to want of page space, but in practice, the battery packs 900 are collected from more vehicles. The collector 10 disassembles the collected battery packs 900A to 900C and extracts a plurality of cells from the battery packs 900A to 900C (step S101).

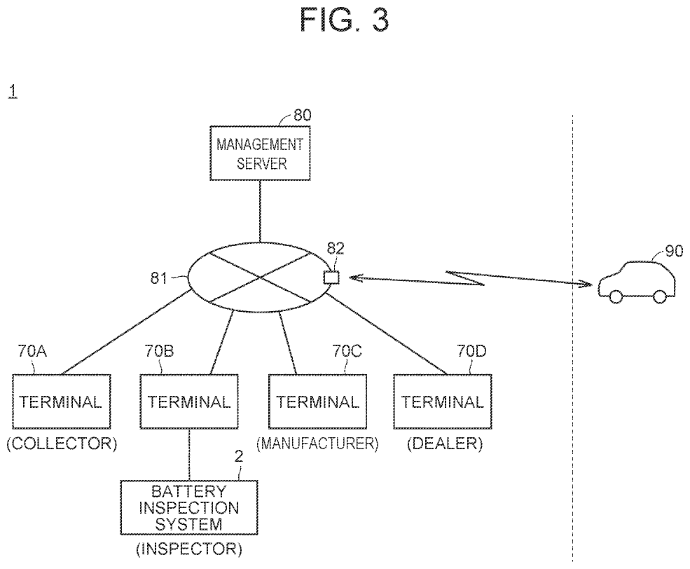

In the battery distribution model, the cells are each imparted with identification information (hereinafter referred to as “ID”) used to identify the respective cells. The information on the cells is managed by a management server 80 using the IDs. Therefore, the collector 10 transmits the ID of each cell extracted from the battery packs 900A to 900C to the management server 80 using a terminal 70A (see FIG. 3).

An inspector 20 conducts performance inspection of each cell collected by the collector 10 (step S102). Specifically, the inspector 20 inspects electrical properties of the collected cells. For example, the inspector 20 can inspect a full capacity, a resistance value, an open circuit voltage (OCV), a state of charge (SOC), etc. The inspector 20 inspects the remaining level of electrolyte included in each cell in addition to the electrical properties.

Based on the results of inspection, the inspector 20 divides the cells into reusable cells and non-reusable cells, delivers the reusable cells to a manufacturer 30, and delivers the non-reusable cells (cells desirable for resource recycling) to a recycler 50. The inspection results of the cells are transmitted to the management server 80 using a terminal 70B of the inspector 20 (see FIG. 3).

The manufacturer 30 manufactures a new battery pack 900 by reconstructing the cells delivered from the inspector 20 (step S103). In the present embodiment, information (assembly information) for manufacturing the battery pack 900 is generated in the management server 80, and transmitted to a terminal 70C of the manufacturer 30 (see FIG. 3). The manufacturer 30 assembles the cells to manufacturer (rebuild) the battery pack 900 for the vehicle 90 based on the assembly information.

A dealer 40 sells the battery pack 900 manufactured by the manufacturer 30 for use in a vehicle, or sells the battery pack 900 for stationary use in residential locations and the like (step S104). In the present embodiment, the vehicle 90 is brought into the dealer 40. In the dealer 40, the battery pack 900 of the vehicle 90 is replaced with a reused or rebuilt product manufactured by the manufacturer 30.

The recycler 50 disassembles the cells (or stacks) that are determined as non-reusable by the inspector 20, and recycles them for use as raw materials for new cells and other products.

In FIG. 1, the collector 10, the inspector 20, the manufacturer 30, and the dealer 40 are operators different from each other. However, the division of the operators are not limited to this. For example, the inspector 20 and the manufacturer 30 may be the same operator. Alternatively, the collector 10 may be divided into an operator who collects the battery packs 900 and an operator who disassembles the collected battery packs 900. The locations of the operators and the dealer are not particularly limited. The locations of the operators and the dealer may be different from each other, or a plurality of operators or dealers may be placed in the same location.

FIG. 3 shows a configuration example of a battery management system 1 that is applied to the battery distribution model in the present embodiment. With reference to FIG. 3, the battery management system 1 includes the terminals 70A to 70D, the management server 80, a communication network 81, and a base station 82.

The terminal 70A is the terminal of the collector 10. The terminal 70B is the terminal of the inspector 20. The terminal 70C is the terminal of the manufacturer 30. The terminal 70D is the terminal of the dealer 40.

The management server 80 and the terminals 70A to 70D are configured to be communicable with each other via the communication network 81 such as the Internet. The base station 82 of the communication network 81 is configured to be able to exchange information wirelessly with the vehicle 90.

The inspector 20 is provided with a battery inspection system 2. The battery inspection system 2 measures the properties of each cell to evaluate the progress of deterioration. Based on the result of the evaluation regarding the progress degree of deterioration of the cells, the battery inspection system 2 determines a reuse mode (rebuild or recycle) of each corresponding cell. The reuse mode of the cell determined by the battery inspection system 2 is transmitted to the management server 80 via the terminal 70B, for example.

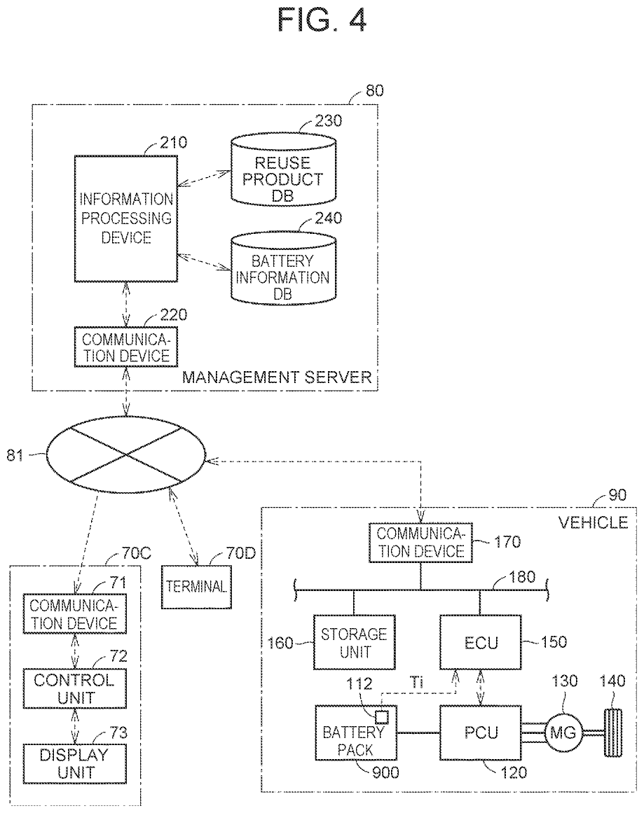

FIG. 4 shows outlined configuration of the vehicle 90, the management server 80, and the terminal 70C of the manufacturer 30 in the embodiment. With reference to FIG. 4, the vehicle 90 includes a battery pack 900, a temperature sensor 112, a power control unit (hereinafter referred to as “PCU”) 120, a motor generator (hereinafter referred to as “MG”) 130, a drive wheel 140, an electronic control unit (hereinafter referred to as “ECU”) 150, a storage unit 160, and a communication device 170, which are interconnected by a bus 180.

The battery pack 900 is constituted of a plurality of cells and configured by, for example, appropriately connecting a plurality of lithium-ion secondary battery cells in series, in parallel, or in series and parallel as appropriate. The battery pack 900 uses the MG 130 to supply electric power to the PCU 120 for driving the drive wheel 140.

The temperature sensor 112 detects temperature Ti of the cells in the battery pack 900 and outputs the detected value to the ECU 150. The temperature sensor 112 detects at least the temperature of a cell (or a module) arranged in the vicinity of the outer circumference of the battery pack and the temperature of a cell (or a module) arranged in the center of the battery pack.

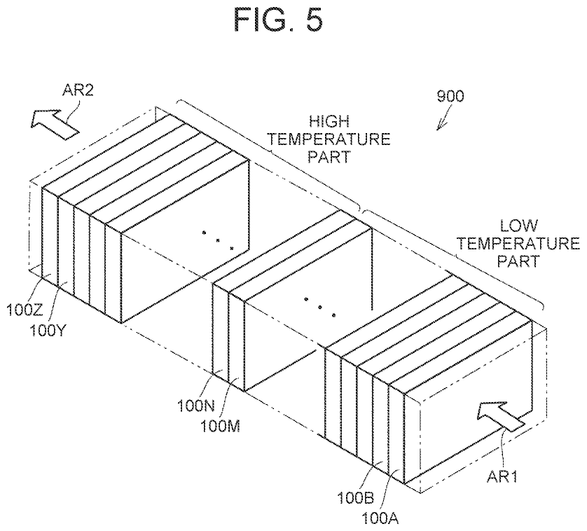

FIG. 5 is an explanatory view of an example of temperature distribution in the battery pack 900 mounted on the vehicle 90 in the first embodiment. With reference to FIG. 5, the battery pack 900 typically to be mounted on the vehicle includes tens to hundreds of cells. However, the number of cells included in the battery pack 900 is not particularly limited.

The battery pack 900 is provided with a cooling mechanism (not illustrated) to cool the cells 100A to 100Z. The cooling mechanism is a water cooling mechanism using liquid coolant (such as water). The water sent by the water cooling mechanism to the cells 100A to 100Z flows in an array direction of the cells 100A to 100Z indicated by arrows AR1 and AR2. In this way, each of the cells 100A to 100Z is cooled. The cooling method of the cooling mechanism is not particularly limited, and may be an air cooling mechanism that cools the cells with air.

In such configuration, the cooling effect on the cells provided on an upstream side (indicated by the arrow AR1) of the liquid sent by the water cooling mechanism is higher than the cooling effect on the cells provided on a downstream side (indicated by the arrow AR2). Therefore, the cells provided on the upstream side (such as the cell 100A) tend to be lower in temperature than the cells provided on the downstream side (such as the cell 100Z).

In the present embodiment, the cells 100A to 100Z are divided into two parts. The cells 100A to 100M provided on the upstream side are also stated as “low temperature part” and the cells 100N to 100Z provided on the downstream side are also stated as “high temperature part”. The high temperature part is at the region where the temperature becomes equal to or more than a prescribed temperature when the battery pack 900 is used. The low temperature part is at the region where the temperature does not exceed the prescribed temperature when the battery pack 900 is used. Typically, the higher the temperature of a secondary battery is, the faster the deterioration of the secondary battery progresses. It can be said, therefore, that the high temperature part is more susceptible to deterioration than the low temperature part.

With reference to FIG. 4 again, the MG 130 is a rotary electric machine that is, for example, a three-phase alternating motor generator. The MG 130 is driven by the PCU 120 to rotate the drive wheel 140. The MG 130 can also generate regenerative electric power in occasions such as braking the vehicle 90. The electric power generated by the MG 130 is rectified by the PCU 120 and used to charge the battery pack 900.

The PCU 120 includes an inverter and a converter (which are not illustrated) and configured to drive the MG 130 in accordance with a drive signal from the ECU 150. When the MG 130 is power-driven, the PCU 120 converts the electric power stored in the battery pack 900 into an alternating-current electric power and supplies the converted electric power to the MG 130. When the MG 130 is regeneratively driven (e.g., in occasions such as braking the vehicle 90), the electric power generated by the MG 130 is rectified and supplied to the battery pack 900.

The ECU 150 includes a central processing unit (CPU), a memory (read only memory (ROM) and a random access memory (RAM)), and input and output ports for input and output of various signals (which are all not illustrated). The ECU 150 controls the PCU 120 and controls charge and discharge of the battery pack 900 such that the vehicle 90 is in a desired state. The ECU 150 also acquires a detection value of the temperature Ti from the temperature sensor 112, generates temperature information on the battery pack 900, and outputs the temperature information to the storage unit 160.

Rebuild information used to manufacture a rebuild product is generated in the management server 80. Accordingly, the ECU 150 generates the temperature information on the battery pack 900 and stores the generated temperature information in the storage unit 160. The ECU 150 periodically reads the temperature information from the storage unit 160 and transmits the temperature information to the management server 80 via the communication device 170.

The management server 80 includes an information processing device 210, a communication device 220, a reuse product database (hereinafter referred to as “DB”) 230, and a battery information DB 240.

The reuse product DB 230 accumulates information on cells 100 that are included in used battery packs 900A to 900C (see FIG. 1) collected by the collector 10 and that are determined to be reusable by the inspector 20. For example, the information is collected by the inspector 20 conducting performance evaluation (evaluation of deterioration status) of each of the cells 100. The information includes the deterioration status of each of the cells 100, and indexes indicating the deterioration resistance of the cells 100 (such as deterioration speed, cell capacity, cell resistance, negative electrode thickness, and basis weight).

The battery information DB 240 stores the temperature information on the battery pack 900, which are periodically received from the vehicle 90, in association with an ID that identifies the vehicle 90.

The information processing device 210 includes a CPU, a memory, and an input and output buffer (which are not illustrated). When the information processing device 210 receives information to identify the vehicle 90, which has the battery pack 900 scheduled to be replaced, from the terminal 70D of the dealer 40 through the communication device 220, the information processing device 210 generates rebuild information for rebuilding the battery pack 900 by using data about the vehicle 90 stored in the battery information DB 240 and data about the reusable cells 100 stored in the reuse product DB230. The details of specific processing for generating the rebuild information will be discussed later. The information processing device 210 then transmits the generated rebuild information to the terminal 70C of the manufacturer 30 through the communication device 220.

The terminal 70C of the manufacturer 30 includes a communication device 71, a control unit 72, and a display unit 73. The communication device 71 acquires the rebuild information generated by the management server 80 from the management server 80. The control unit 72 selects replacement cells from the cells inspected by the inspector 20 based on the acquired rebuild information, and displays information on the selected replacement cells on the display unit 73. The manufacturer 30 manufactures a rebuilt product that is the battery pack 900 for the vehicle 90 based on the information on the replacement cells displayed on the display unit 73. The configuration of the terminals 70A, 70B, 70D is similar to the configuration of the terminal 70C.

In the past, there was a method of reusing the cells 100. In the method, when the battery pack 900 is reconstructed, battery characteristics of the cells 100 that constitute the battery pack 900 are acquired, the cells 100 are classified using an allowable range of variation that varies in accordance with the acquired battery characteristics, and the battery pack 900 is reconstructed for each classified cells 100. When the battery pack 900 is mounted on the vehicle 90 and used, the temperature of the battery pack 900 varies depending on the portions of the battery pack 900. The battery characteristics of the cells 100 that constitute the battery pack 900 are not the only factor that relates to the life of the battery pack 900

Accordingly, a reconstructing method of the battery pack 900 is a reconstructing method of the battery pack 900 including a plurality of laminated cells 100 each having a seal part. The reconstructing method includes: an acquisition step of acquiring a prescribed index value indicating the state of the seal part; and an arrangement determination step of determining arrangement of the cells 100 in reconstruction of the battery pack 900 in accordance with the state of the seal part indicated by the acquired prescribed index value.

Therefore, the arrangement of the cell 100 in reconstruction of the battery pack 900 is determined in accordance with the state of the seal part indicated by the prescribed index value indicating the state of the seal part of the cell 100. When the battery pack 900 is used, influence on the seal part of the cell 100 is different depending on the arrangement of the cell 100. The life of the cell 100 varies depending on the state of the seal part of the cell 100. Therefore, it is possible to reconstruct the cells 100 into the battery pack 900 so as to extend the life of the cells 100. As a result, it is possible to extend the life of the battery pack 900 after reconstruction.

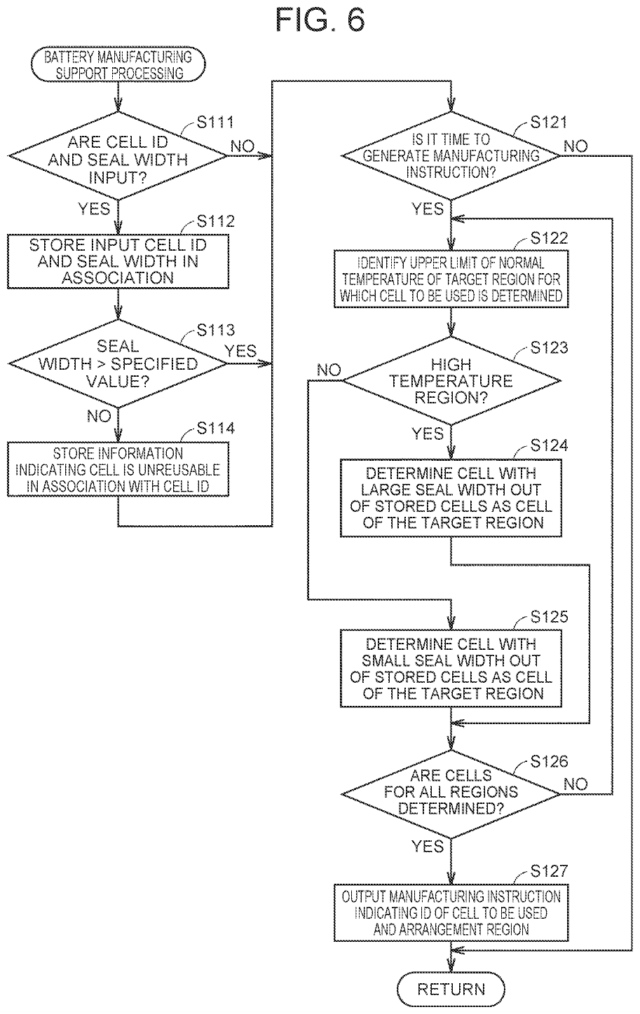

FIG. 6 is a flowchart showing a flow of battery manufacturing support processing in the first embodiment. With reference to FIG. 6, the battery manufacturing support processing is executed by the information processing device 210 of the management server 80.

First, the information processing device 210 determines whether or not input of the ID of the cell 100 and the seal width of the cell 100 are received from the terminal 70B of the inspector 20 (step S111).

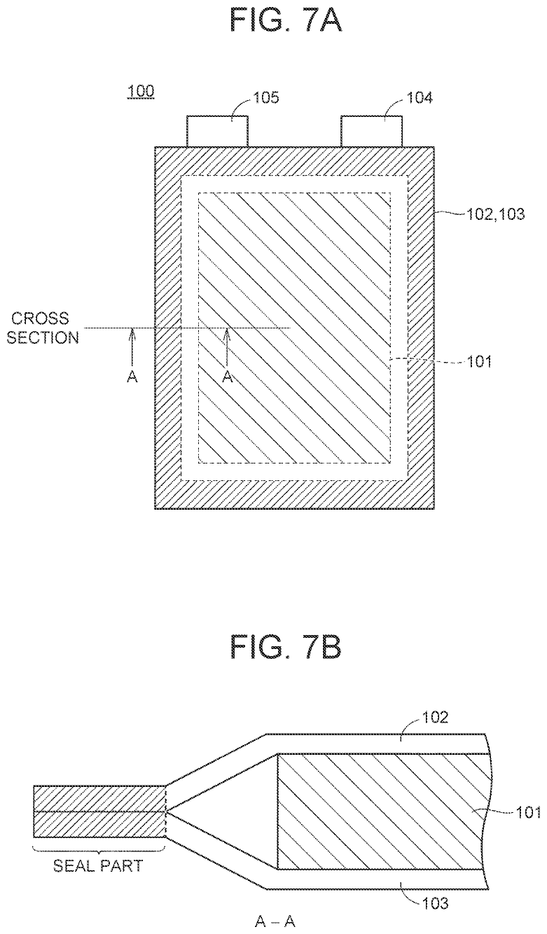

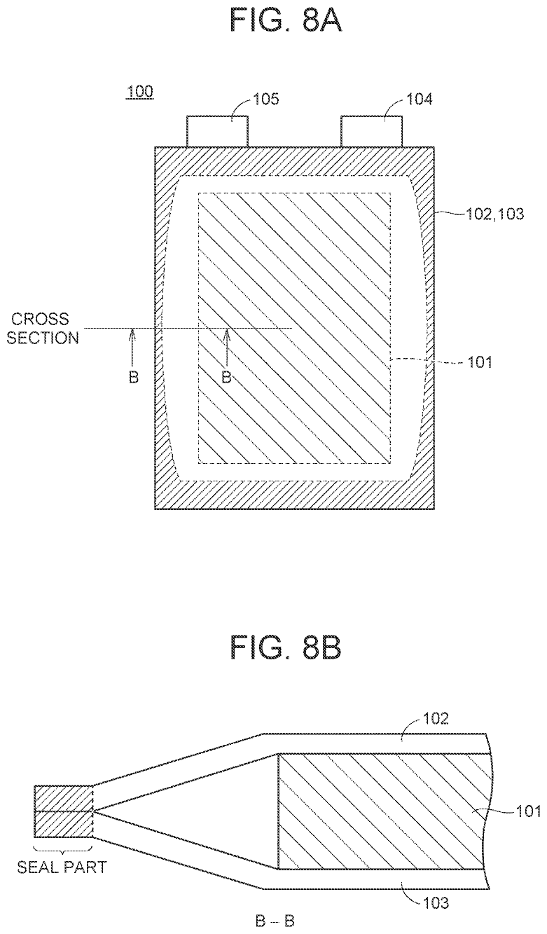

Here, inspection of the seal width by the inspector 20 will be described. FIGS. 7A, 7B, 8A and 8B are views for describing inspection of the seal width of the cell 100 in the embodiment. FIGS. 7A and 8A show plan views of the cell 100. FIGS. 7B and 8B show partial sectional views of the cell 100.

In the embodiment, the cell 100 is a laminated lithium-ion secondary battery. The cell 100 may be a secondary battery of other types (for example, a lithium-ion polymer secondary battery, or an all-solid battery) as long as it is laminated.

With reference to FIGS. 7A, 7B, 8A and 8B, the cell 100 includes an electrode body 101, a first surface-side laminate film 102, a second surface-side laminate film 103, a positive electrode tab 104, and a negative electrode tab 105.

The electrode body 101 includes a plurality of positive electrodes, a plurality of negative electrodes, and a plurality of separators. The positive electrodes and the negative electrodes are stacked alternately. The positive electrodes each have a positive-electrode active material that stores lithium (Li) ions. The negative electrodes each have a negative-electrode active material that stores lithium ions. The separators are arranged between the positive electrodes and the negative electrodes. The separators are formed with an insulating material that allows the lithium ion to pass through.

The first surface-side laminate film 102 and the second surface-side laminate film 103 hold the electrode body 101. Although not illustrated, an electrolyte is also enclosed, along with the electrode body 101, in an internal space between the first surface-side laminate film 102 and the second surface-side laminate film 103. The first surface-side laminate film 102 and the second surface-side laminate film 103 have seal parts (hatched areas around the outer circumferences of the first surface-side laminate film 102 and the second surface-side laminate film 103 shown in A-A sectional view in FIG. 7B, and B-B sectional view in FIG. 8B) along the outer edge in the plan views in FIGS. 7A and 8A. The outer edges of the first surface-side laminate film 102 and the second surface-side laminate film 103 are rectangular in the plan view, for example.

The first surface-side laminate film 102 and the second surface-side laminate film 103 each have a film base made of metal (e.g., aluminum (Al)) and resin layers formed on both sides of the film base. The seal part is formed by heating and welding the resin layers of the first surface-side laminate film 102 and the second surface-side laminate film 103 in contact with each other. As shown in FIGS. 7A and 7B, when the cell 100 is a new product immediately after manufacturing, the seal part has a fixed width from the outer edges of the first surface-side laminate film 102 and the second surface-side laminate film 103 on each of the long sides and the short sides.

As the cell 100 continues to be charged and discharged, gas is generated from the electrolyte, so that the pressure inside the space where the electrolyte is trapped between the first surface-side laminate film 102 and the second surface-side laminate film 103 may increase. Due to the increase of the pressure, force is applied in the direction of separating the seal part. Accordingly, while the width of the seal part is uniform when the cell 100 is new as shown in FIGS. 7A and 7B, some width of the seal part may partially become smaller than when the cell 100 is new due to continuous use of the cell 100 as shown in FIGS. 8A and 8B. When the width of the seal part (also referred to as “seal width”) becomes zero, the cell 100 may possibly be opened.

For this reason, the seal width is measured by the inspector 20. Specifically, a device for measuring the length, such as a vernier caliper or a ruler, is used to measure the seal width of a portion of the seal part where the thickness is constant. As shown in FIG. 8A, since it is relatively often the case that the seal width in the middle of the long sides of the cell 100 becomes the smallest among the entire circumference, the seal width in the middle of at least one of the long sides of the cell 100 is measured. However, since the width of a portion of the seal part with poor welding may become the smallest among the entire circumstance in some cases, it is desirable to measure the seal width in a plurality of portions. Since it is also possible to recognize the portion with a small seal width by visual inspection, it is also desirable to measure the seal width of the portion recognized to have a small seal width by visual inspection.

The inspector 20 inspects the seal width of the cell 100 in this way, and inputs the measured seal width and the ID of the cell 100 into the terminal 70B. The input seal width and the ID of the cell 100 are associated with each other, and accumulated in the storage device of the terminal 70B. The terminal 70B transmits a combination of the seal width and the ID of the cell 100 to the management server 80 at predetermined timing.

Back in FIG. 6, when the information processing device 210 receives a combination of the seal width and the ID of the cell 100 from the terminal 70B, the information processing device 210 determines that input of these data is received (YES in step S111), and accumulates the received seal width in association with the ID of the cell 100 in the reuse product DB 230 (step S112).

After step S112, the information processing device 210 determines whether or not the seal width exceeds a specified value (step S113). The specified value is a value to determine that the cell 100 is not desirable for reuse when the seal width is equal to or less than the specified value. When determination is made that the seal width does not exceed the specified value (NO in step S113), the information processing device 210 accumulates the information indicating that the cell 100 is unreusable in association with the ID of the cell 100 in the reuse product DB 230 (step S114).

When determination is made that input of the cell ID and the seal width is not received (NO in step S111), when determination is made that the seal width is above the specified value (YES in step S113), or after step S114, the information processing device 210 determines whether or not it is the time to generate an instruction for manufacturing the battery pack 900 to the manufacturer 30 (step S121).

When determination is made that it is the time of generating the manufacturing instruction (YES in step S121), the information processing device 210 identifies an upper limit of normal temperature of a target region of the battery pack 900 for which the cell 100 to be used is determined (step S122). The normal temperature of each region of the battery pack 900 is the temperature during traveling and charging. The normal temperature is detected by the temperature sensor 112 of the vehicle 90 and accumulated in the battery information DB 240 of the management server 80. The normal temperature does not include abnormal temperature. In step S122, out of the temperatures accumulated in the battery information DB, the upper limit of the temperature of the region, for which the cell 100 to be used is determined, is identified.

The information processing device 210 determines whether or not the target region for which the cell to be used is determined is a high temperature region where the identified upper limit of the temperature is higher than a prescribed temperature (step S123). As shown in FIG. 5 before, the high temperature region tends to be on the downstream side of the water cooling mechanism. When determination is made that the target region for which the cell to be used is determined is the high temperature region (YES in step S123), the information processing device 210 determines, out of the cells 100 accumulated in the reuse product DB 230, the cell 100 with a large seal width (for example, larger than a prescribed limit width) as the cell 100 to be arranged at the target region (step S124).

When determination is made that the target region for which the cell to be used is determined is not the high temperature region (NO in step S123), the information processing device 210 determines, out of the cells 100 accumulated in the reuse product DB 230, the cell 100 with a small seal width (for example, less than the prescribed limit width) as the cell 100 to be arranged at the target region (step S125).

After step S124 or step S125, the information processing device 210 determines whether the cell 100 to be used is determined for all the regions of the battery pack 900 (step S126). When determination is made that the cell 100 to be used is not determined for all the regions (NO in step S126), the information processing device 210 returns the processing to be executed to step S122.

When determination is made that the cell 100 to be used is determined for all the regions (YES in step S126), the information processing device 210 outputs to the terminal 70C of the manufacturer 30 a manufacturing instruction indicating a combination of the ID of the cell 100 to be used and the region of the battery pack 900 where the cell 100 is arranged (step S127).

When the manufacturer 30 receives the manufacturing instruction from the information processing device 210 of the management server 80, the manufacturer 30 manufactures the battery pack 900 by arranging the specified cell 100 at a specified region according to the manufacturing instruction as shown in step S103 in FIG. 2.

### Second Embodiment

In the first embodiment, as shown in FIGS. 5 and 6, the battery pack 900 is divided into the high temperature part and the low temperature part, and the cells 100 with a relatively large seal width are arranged in the high temperature part while the cells 100 with a relatively small seal width are arranged in the low temperature part.

In a second embodiment, the temperature range of the battery pack 900 is divided into two or more stages, and the cells 100 are arranged according to the seal width.

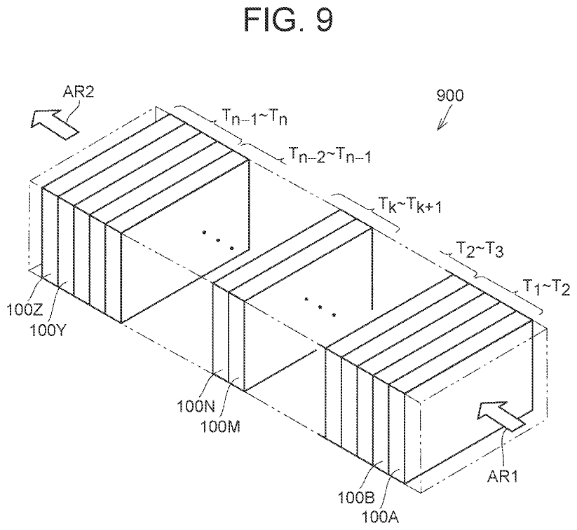

FIG. 9 is an explanatory view of an example of temperature distribution in the battery pack 900 mounted on the vehicle 90 in the second embodiment. In the first embodiment, the temperature range of the battery pack 900 is divided into the high temperature part and the low temperature part as shown in FIG. 5. With reference to FIG. 9, in the second embodiment, the temperature range of the battery pack 900 is divided into portions where the upper limit of normal temperature is T1 to T2, T2 to T3, Tk to Tk+1, Tn−2 to Tn−1, and Tn−1 to Tn (T1<T2< . . . <Tk<Tk+1< . . . <Tn−2>Tn−1<Tn).

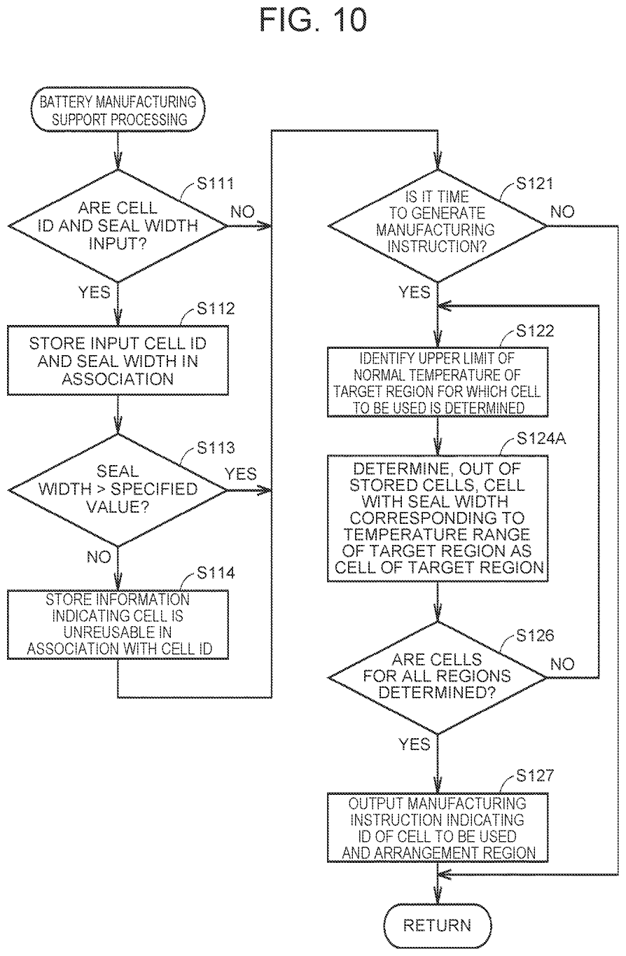

FIG. 10 is a flowchart showing a flow of battery manufacturing support processing in the second embodiment. With reference to FIG. 10, the battery manufacturing support processing is executed by the information processing device 210 of the management server 80. In the battery manufacturing support processing in FIG. 10, processing other than step S124A is in common with the battery manufacturing support processing shown in FIG. 6. Hence, redundant description is not repeated.

After step S122 shown in FIG. 6, the information processing device 210 determines, out of the cells 100 accumulated in the reuse product DB 230, the cell 100 with a seal width corresponding to the temperature range including the identified upper limit of normal temperature at the target region in step S122, as the cell 100 of the target region (step S124A), and proceeds the processing to be executed to step S126 shown in FIG. 6.

### Other Modifications

(1) In the embodiments disclosed, as shown in FIGS. 6 to 8B and FIG. 10, the index indicating the state of the seal part is the seal width of the seal part that is the smallest among the entire outer circumference at the time of measurement. However, without being limited to this, the index value indicating the state of the seal part may be any index value indicating the state of welding of the seal part at the time of measurement. The index value may be a ratio of the smallest width of the seal part in the entire circumference at the time of measurement to the seal width of the cell 100 in a new product state immediately after manufacturing. The index value may be an average of the seal widths at a plurality of portions in the entire circumference at the time of measurement. The index value may be a ratio of the average value of the seal widths at the time of measurement to the seal width of the cell 100 in a new product state immediately after manufacturing. The index value may be a ratio of the welding area at the time of measurement to the welding area of the seal part of the cell 100 in a new product state immediately after manufacturing. The index value may be the number of portions where the seal width is less than a prescribed threshold, among a prescribed number of portions in the entire circumference at the time of measurement.

(2) In the embodiments disclosed, the temperature of each part of the battery pack 900 is detected by the temperature sensor 112 of the vehicle 90 and periodically transmitted to the management server 80. As a consequence, the temperature range of each part of the battery pack 900 as shown in FIGS. 5 and 9 is identified. However, without being limited to this, the temperature range of each part of the battery pack 900 may be identified in advance by experimentation or simulation.

(3) In the embodiments disclosed, inspecting the cells 100 of the battery pack 900 and reconstructing the cells 100 into the battery pack 900 are executed by the operator. However, without being limited to this, inspecting the cells 100 of the battery pack 900 and reconstructing the cells 100 into the battery pack 900 may automatically be executed by machines such as inspection devices, manufacturing machines, and robots.

(4) In the embodiments disclosed, the battery pack 900 is constructed by arranging the cells 100 having seal widths according to the temperature of each part of the battery pack 900 as shown in steps S122 to S125 in FIG. 6 and in steps S122 and S124A in FIG. 10. However, without being limited to the configuration, the cells 100 may be arranged in such order that the cells 100 having smaller seal widths are arranged on the more upstream side where the effect of the cooling mechanism to cool the cells 100 is higher and the cells 100 having larger seal widths are arranged on the more downstream side where the cooling effect is relatively lower, regardless of the temperature of each part of the battery pack 900.

(5) The embodiments disclosed can be interpreted as the reconstructing method of the battery pack 900, the manufacturing method of the battery pack 900, the battery pack 900, the manufacturing support device for the battery pack 900, and the manufacturing support method for the battery pack 900.

### CONCLUSION

(1) As shown in FIGS. 1 to 10, the reconstructing method of the battery pack 900 is a reconstructing method of the battery pack 900 including a plurality of laminated cells 100 each having a seal part. As shown in FIGS. 6 and 10, the reconstructing method includes an acquisition step of acquiring a prescribed index value indicating the state of the seal part (for example, step S112 in FIGS. 6 and 10), and an arrangement determination step of determining arrangement of the cells 100 in reconstruction of the battery pack 900 in accordance with the state of the seal part indicated by the acquired prescribed index value (for example, step S122 to step S126 in FIGS. 6 and 10).

Therefore, the arrangement of the cell 100 in reconstruction of the battery pack 900 is determined in accordance with the state of the seal part indicated by the prescribed index value representing the state of the seal part of the cell 100. When the battery pack 900 is used, influence on the seal parts of the cells 100 is different depending on the arrangement of the cells 100. The life of the cells 100 varies depending on the state of the seal parts of the cells 100. Therefore, it is possible to reconstruct the cells 100 into the battery pack 900 so as to extend the life of the cells 100. As a result, it is possible to extend the life of the battery pack 900 after reconstruction.

(2) As shown in FIGS. 6 and 10, in the acquisition step, the prescribed index value is acquired by measuring the prescribed index value of the seal part of the cell 100 that is disassembled from the collected battery pack 900 (for example, step S111 and step S112 in FIGS. 6 and 10), and the reconstructing method further includes a step of determining not to use the cell 100 for reconstruction of the battery pack 900 when the acquired prescribed index value of the cell does not satisfy a specified value (for example, step S113 and step S114 in FIGS. 6 and 10). Therefore, when the seal part of the certain cell 100 has a prescribed index value that does not satisfy the prescribed value, using the cell 100, which affects the life of the reconstructed battery pack 900, for reconstruction of the battery pack 900 can be avoided. As a result, it is possible to extend the life of the battery pack 900 after reconstruction.

(3) As shown in FIGS. 5, 6, 9 and 10, in the arrangement determination step, as the state of the seal part indicated by the acquired prescribed index value is better, the cell of the prescribed index value may be determined to be arranged at the region where temperature becomes higher when the battery pack 900 is used. The region where the temperature rises when the battery pack 900 is used has a large influence on the seal region. Therefore, the cell 100 having the seal part in a good state can be arranged at the region where the seal part is largely influenced. As a result, it is possible to extend the life of the battery pack 900 after reconstruction.

(4) As shown in FIGS. 5 and 6, in the arrangement determination step, when the prescribed index value is equal to or more than a prescribed value representing a good state of the seal part, the cell 100 of the prescribed index value may be determined to be arranged at the region where temperature becomes equal to or more than a prescribed temperature when the battery pack 900 is used (for example, step S124 in FIG. 6), whereas when the prescribed index value is less than the prescribed value, the cell 100 of the prescribed index value may be determined to be arranged at the region where temperature does not become equal to or more than the prescribed temperature when the battery pack 900 is used (for example, step S125 in FIG. 6). Therefore, it is possible to arrange the cell 100 having the seal part in a good state at the region where the seal part receives a relatively large influence, and to arrange the cell 100 having the seal part in a poor state at the region where the seal part receives a relatively small influence. As a result, it is possible to extend the life of the battery pack 900 after reconstruction.

(5) As shown in FIGS. 1 to 10, the manufacturing method of the battery pack 900 is a manufacturing method of the battery pack 900 including a plurality of laminated cells 100 each having a seal part. As shown in FIGS. 2, 6 and 10, the manufacturing method includes: a step of acquiring a prescribed index value indicating the state of the seal part of the cell 100 that is disassembled from the collected battery pack 900 (for example, step S101 and step S102 in FIG. 2, step S111 to step S114 in FIGS. 6 and 10); a step of determining a region where the cell 100 is arranged in reconstruction of the battery pack 900 in accordance with the state of the seal part indicated by the acquired prescribed index value (for example, step S122 to step S127 in FIGS. 6 and 10); and a step of reconstructing the battery pack 900 by arranging the cell 100 at the determined region (step S103 in FIG. 2). As a result, it is possible to extend the life of the battery pack 900 after reconstruction.

(6) The battery pack 900 is manufactured by the manufacturing method according to the aspect (5). As a result, it is possible to extend the life of the battery pack after reconstruction.

(7) As shown in FIGS. 1 to 10, the manufacturing support apparatus (for example, the management server 80) for the battery pack 900 is a manufacturing support apparatus for the battery pack 900 including a plurality of laminated cells 100 each having a seal part. As shown in FIG. 4, the manufacturing support apparatus includes an arithmetic processing unit (for example, the CPU of the information processing device 210) and a storage unit (for example, the memory of the information processing device 210, the reuse product DB 230, and the battery information DB 240). As shown in FIGS. 6 and 10, the arithmetic processing unit is configured to store the acquired prescribed index value indicating the state of the seal part in the storage unit (for example, step S111 and step S112 in FIGS. 6 and 10); and determining arrangement of the cell 100 in reconstruction of the battery pack 900 in accordance with the state of the seal part indicated by the prescribed index value stored in the storage unit (for example, step S122 to step S126 in FIGS. 6 and 10). As a result, it is possible to extend the life of the battery pack 900 after reconstruction.

(8) As shown in FIGS. 1 to 10, the manufacturing support method for the battery pack 900 is a manufacturing support method for the battery pack 900 including a plurality of laminated cells 100 each having a seal part. As shown in FIGS. 4, 6, and 10, the manufacturing support method is executed by a manufacturing support apparatus (for example, the management server 80) including an arithmetic processing unit (for example, the CPU of the information processing device 210) and a storage unit (for example, the memory of the information processing device 210, the reuse product DB 230, and the battery information DB 240). As shown in FIGS. 6 and 10, the manufacturing support method includes a step of the arithmetic processing unit storing an acquired prescribed index value indicating the state of the seal part in the storage unit (for example, step S111 and step S112 in FIGS. 6 and 10); and a step of the arithmetic processing unit determining arrangement of the cell in reconstruction of a battery pack in accordance with the state of the seal part indicated by the prescribed index value stored in the storage unit (for example, step S122 to step S126 in FIGS. 6 and 10). As a result, it is possible to extend the life of the battery pack 900 after reconstruction.

The respective embodiments disclosed are also planned to be implemented in appropriate combination. It should be understood that the embodiments disclosed are in all respects illustrative and are not considered as the basis for restrictive interpretation. The scope of the present disclosure is not defined by the foregoing description of the embodiments. Rather, it is defined by the range of appended claims. All changes which come within the range of the claims and meaning and the range of equivalency thereof are therefore intended to be embraced therein.

What is claimed is:

1. A reconstructing method of a battery pack including a plurality of laminated cells each having a seal part, the reconstructing method comprising:
an acquisition step of acquiring a prescribed index value indicating a state of the seal part; and
an arrangement determination step of determining arrangement of the cells in reconstruction of the battery pack in accordance with the state of the seal part indicated by the acquired prescribed index value.

2. The reconstructing method according to claim 1, wherein:
in the acquisition step, the prescribed index value is acquired by measuring the prescribed index value of the seal part of the cell that is disassembled from the collected battery pack; and
the reconstructing method further includes a step of determining not to use the cell for reconstruction of the battery pack when the acquired prescribed index value of the cell does not satisfy a specified value.

3. The reconstructing method according to claim 1, wherein in the arrangement determination step, as the state of the seal part indicated by the acquired prescribed index value is better, the cell of the prescribed index value is determined to be arranged at a region where temperature becomes higher when the battery pack is used.

4. The reconstructing method according to claim 3, wherein in the arrangement determination step, when the prescribed index value is equal to or more than a prescribed value representing a good state of the seal part, the cell of the prescribed index value is determined to be arranged at a region where temperature becomes equal to or more than a prescribed temperature when the battery pack is used, whereas when the prescribed index value is less than the prescribed value, the cell of the prescribed index value is determined to be arranged at a region where temperature does not become equal to or more than the prescribed temperature when the battery pack is used.

5. A manufacturing method of a battery pack including a plurality of laminated cells each having a seal part, the manufacturing method comprising:
a step of acquiring a prescribed index value indicating a state of the seal part of the cell that is disassembled from the collected battery pack;
a step of determining a region where the cell is arranged in reconstruction of the battery pack in accordance with the state of the seal part indicated by the acquired prescribed index value; and
a step of reconstructing the battery pack by arranging the cell at the determined region.

6. A battery pack manufactured by the manufacturing method according to claim 5.

7. A manufacturing support apparatus for a battery pack including a plurality of laminated cells each having a seal part, the manufacturing support apparatus comprising:
an arithmetic processing unit; and
a storage unit, wherein the arithmetic processing unit is configured to
store an acquired prescribed index value indicating a state of the seal part in the storage unit, and
determine arrangement of the cell in reconstruction of the battery pack in accordance with the state of the seal part indicated by the prescribed index value stored in the storage unit.

8. A manufacturing support method for a battery pack including a plurality of laminated cells each having a seal part, the manufacturing support method being executed by a manufacturing support apparatus including an arithmetic processing unit and a storage unit, the manufacturing support method comprising:
a step of the arithmetic processing unit storing an acquired prescribed index value indicating a state of the seal part in the storage unit; and
a step of the arithmetic processing unit determining arrangement of the cell in reconstruction of the battery pack in accordance with the state of the seal part indicated by the prescribed index value stored in the storage unit.
